(19) United States
(12) Patent Application Publication
(10) Pub. No.: US 2006/0254044 A1
(43) Pub. Date: Nov. 16, 2006

(54) Power tool assembly

(76) Inventor: Xu Fei Hao, Zhejiang (CN)

Correspondence Address: KATTEN MUCHIN ROSENMAN LLP, 575 MADISON AVENUE, NEW YORK, NY, 10022-2585, US

(21) Appl. No.: 11/288,984

(22) Filed: Nov. 29, 2005

Related U.S. Application Data
(60) Provisional application No. 60/631,776, filed on Nov. 30, 2004.

(51) Int. Cl. B23P 23/00

(52) U.S. Cl. 29/560

(57) ABSTRACT

A power tool assembly includes a tool body housing a drive mechanism and an attaching assembly, which is configured to selectively receive a plurality of interchangeable tool heads. The interchangeable tool heads each are provided with a transmission for coupling accessories, which are releasably mounted to the tool heads, to the drive mechanism.

### RELATED APPLICATIONS

This application is the non-provisional counterpart and claims priority to U.S. Provisional Application 60/631,776 filed on Nov. 30, 2004, which is hereby incorporated by reference in its entirety for all purposes.

### BACKGROUND OF THE INVENTION

1. Field of the Invention

The present invention relates to a power tool and, in particular, to a power tool assembly provided with a plurality of interchangeable tool heads.

2. Description of the Related Art

As a result of considerable developments within the field of power tools and the increased market demand, the number of different types of power tool available to the consumer has risen considerably in the past decade. Power drills and jigsaws have become particularly popular among a wide segment of consumers. In addition, electric sanders, chisels, and other specialized tools, which have dedicated purpose, are gaining their popularity.

While this considerable array of power tools is useful, owning such a large number is both expensive and requires a considerable amount of storage space. In addition, having one specialized tool to perform each job often results in significant under-use of such a tool, since many power tools, generally, are all operated by similar actuators.

Still further, many of known power tools are “cordless”, being powered by rechargeable batteries, often requiring the user to change the battery pack when changing dedicated tools, or have several ready-charged batteries available for different tools. These current solutions are cumbersome or expensive respectively.

Attempts have been made to improve use of such power tools and to provide solutions to the above problems by the inclusion of attachments for a conventional drill, whereby the drill chuck is used to engage a drive mechanism of a reciprocating saw blade. However, such a multi-functional tool still performs limited functions and, thus, cannot fully meet all of the user's needs.

A need thus exists for a power tool assembly, which alleviates the aforementioned problems.

A further need exists for a power tool assembly provided with a single actuator operative to selectively drive a variety of tools, each of which has a dedicated purpose.

Still a further need exists for a power tool assembly having a simple, safe and easily operated structure.

### SUMMARY OF THE INVENTION

A power tool assembly configured in accordance with this invention meets these needs. The assembly comprises a tool body and a plurality of interchangeable tool attachments each configured to perform a specific task. Enclosed in the tool body is an actuating assembly having a rotary output shaft, which is activated by an on/off switch. Configuration of the rotary output allows the user to selectively mount each of the attachments to the tool body and lock the mounted attachment in the desired operative position.

Each of the multiple attachments is configured with a respective tool head shaped and dimensioned to perform a dedicated function. The tool head has an housing enclosing an attaching mechanism, which allows the user to promptly dismount a current tool head and attach another tool head capable of performing the desirable task. Furthermore, the housing also encloses a transmission mechanism operative to transfer the motion of the rotary output to motion of accessories attached to the tool head.

Mounting the transmission mechanism within the housing of attachments improves ergonomics of the entire assembly and simplifies its overall structure. In contrast, many of the known multi-purpose power tool assemblies have a transmission mechanism located in the tool body. Such a structure typically requires additional adapters making the structure of the tool body both complicated and cumbersome.

To prevent unfortunate accidents, the assembly features several safety mechanisms. For example, the tool body is provided with an attachment lock allowing the user to change the attachments only in its unlocked position corresponding to the idle state of the tool assembly. At least some of the attachments have additional locks preventing accessories from accidental disengagement from the attachment.

The assembly includes a continuously variable speed controller conveniently located on the tool body and allowing the user to operate the assembly at the desirable speed.

A variety of tool heads performing numerous functions is contemplated within the scope of this invention. Purely for the illustrative purposes, the attachments disclosed in this application include sawing, chiseling, sanding and drilling attachments.

These and other features and aspects of the present invention will be better understood with reference to the following description and figures.

### BRIEF DESCRIPTION OF THE DRAWINGS

FIG. 1 is a perspective view of a tool body of a power tool assembly configured in accordance with the invention;

FIG. 1A is a top view of the tool body of FIG. 1 shown in the disassembled state of the tool body;

FIG. 2 is a view of an actuating mechanism mounted in the tool body with half the body removed;

FIG. 3 is a view of the other half of the tool body illustrated in FIGS. 1-2;

FIG. 4 is a perspective view of a chiseling unit shown in an assembled state;

FIG. 5 is a front view of halves of the chiseling unit of FIG. 4 shown, thus, in a disassemble state;

FIG. 6 is a top view of a transmitting and actuating mechanism of the chiseling unit;

FIG. 7 is a view similar of FIG. 5, but in addition showing a collet nut, configured to fix accessories to the chiseling attachments, and a tightening cap, configured to attach the halves of the chiseling unit to one another in an assembled state;

FIG. 8 is a perspective view of a reciprocating saw unit;

FIG. 9 is a front view of the saw unit and an accessory attaching mechanism;

FIG. 10 is a top view of the saw unit with half the head of the saw attachment removed;

FIG. 11 is a top view of the saw unit with other half of the saw head removed;

FIG. 12 is a view of a drilling unit shown in an assembled state;

FIG. 13 is a top view of the drilling unit shown in a disassembled state;

FIG. 14 is a view of a sanding unit shown in an assembled state;

FIG. 15 is a side view of the sanding unit shown in a disassembled state;

FIG. 16 is a front view of a transmitting mechanism of the sand unit with half the head of the sand unit removed;

FIG. 17 is a view illustrating various accessories of the power tool assembly; and

FIG. 18 is a view of a carrier toolbox housing the power tool assembly.

### DETAILED DESCRIPTION OF THE INVENTION

Reference will now be made in detail to several embodiments of the invention that are illustrated in the accompanying images. The images are in simplified form and are not to precise scale. For purposes of convenience and clarity only, directional terms, such as top, bottom, left, right, up, down, above, below, proximal, and distal may be used with respect to the drawings. These and similar directional terms should not be construed to limit the scope of the invention in any manner. The words “connect,” “couple,” “attach” and similar terms with their inflectional morphemes do not necessarily denote direct and immediate connections, but also include connections through mediate elements or devices. Additionally, the terms “body” and “housing”, “unit” and attachment”, and “portion” are used interchangeably.

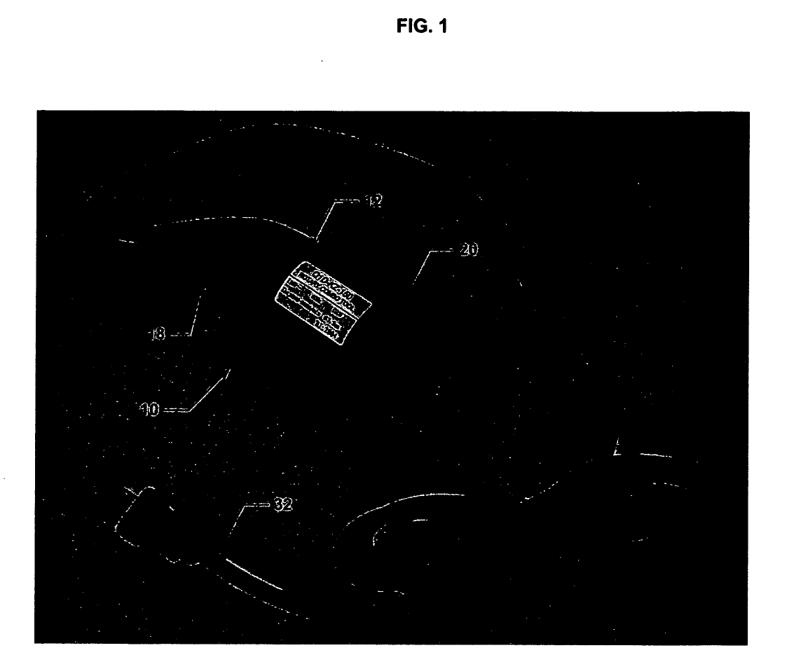

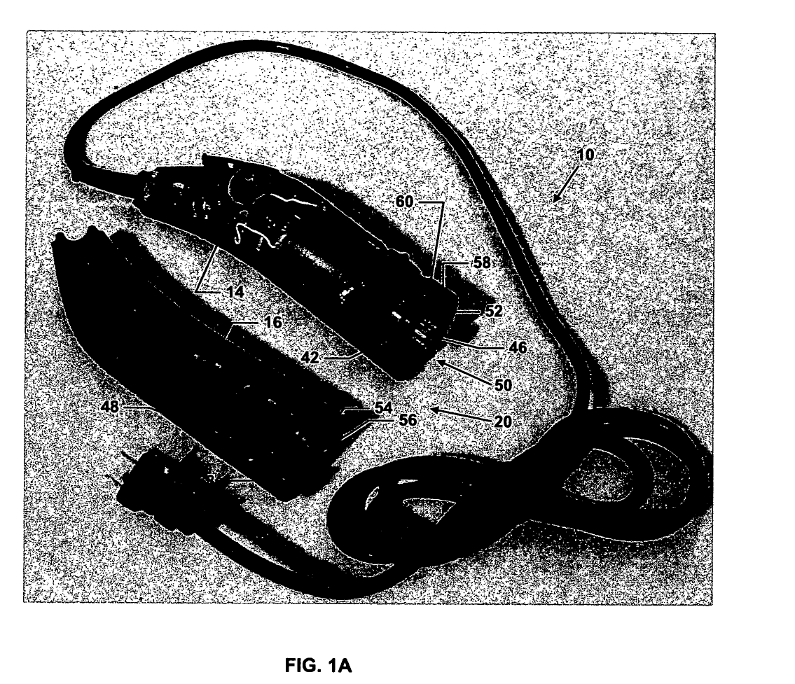

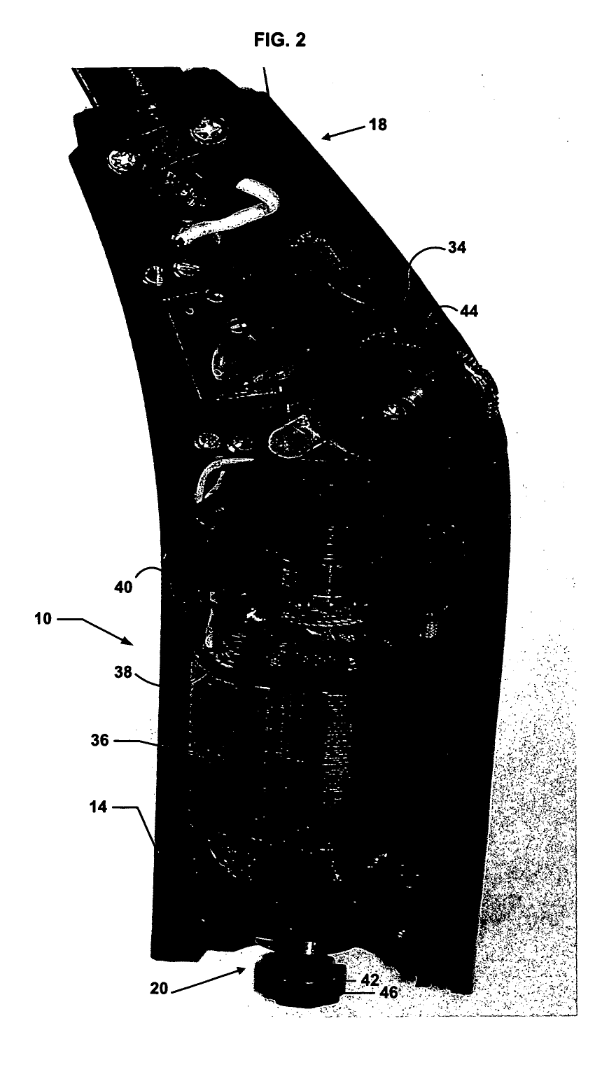

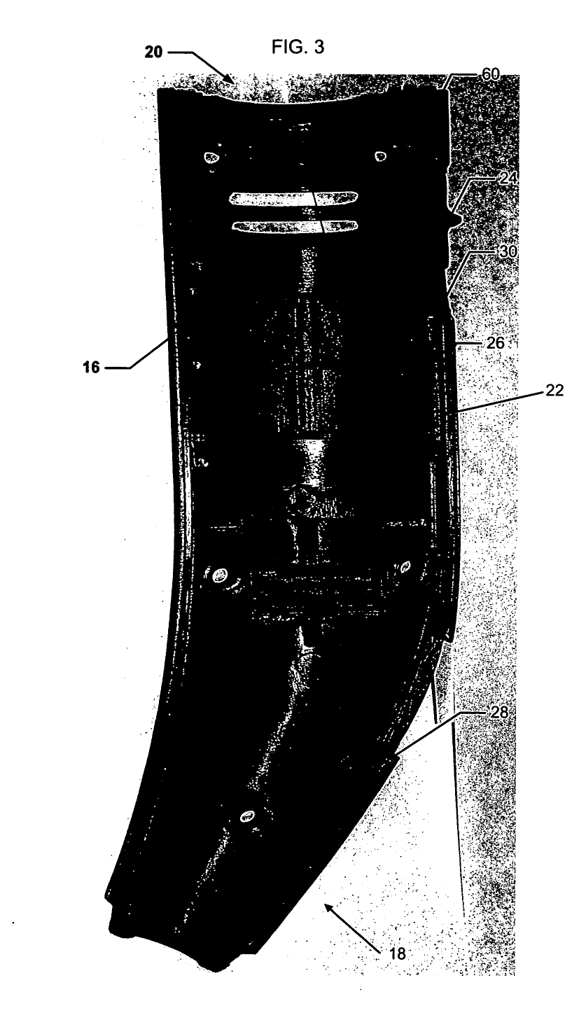

Referring now to FIGS. 1, 1A, 2 and 3, a power tool assembly 10 is configured with a tool body 12 conventionally formed from two halves of a plastic clamshell 14, 16 (FIGS. 2, 3). The two halves are removably attached to one another to encapsulate the internal mechanism of the power tool to be described later.

Tool body 12 is shaped as an elongated, slightly curved body, of which a proximal portion 18 defines a conventional pistol grip to be grasped by the user. Projecting inwardly of proximal portion 18 is an actuating lever 22 (FIG. 3) configured as an elongated strip 26 that is slidably mounted along one side of tool body between two halves 14, 16. Strip 26 is molded with a trigger button 24 (FIG. 3) received in a recess 30 and extending outwards from tool body 12 to be operated by the user's finger. Forcing trigger button 24 towards a distal portion 20 of tool body 12 causes displacement of a trigger 28, which is formed on the proximal end of strip 26, towards distal portion 20 (FIG. 1) of tool body 12. During this displacement, trigger 28 engages and rocks an on/off switch 34 (FIG. 2) to an on-position, in which a drive assembly 36 (FIG. 2) is powered by an external source via a power cord 32 (FIG. 1).

Drive assembly 36 includes an AC motor 38 (FIG. 2) provided with two brushes 40, which are connected to one another in series, and a rotary output shaft 42, which continuously rotates at variable speeds controlled by a speed controller 44. Similar to trigger button 24 (FIG. 3), speed controller 44 extends through tool body 12 and can be rotated by the user's finger to increase or decrease the speed of output shaft 42.

Switch 34, as shown in FIG. 2, has a one-position structure that can be modified to have a forward/reverse configuration for enabling the user to reverse rotation of output shaft 42. To realize the reversal of rotation, actuating lever 22 (FIG. 3) will move linearly towards proximal portion 18 of tool body 12.

Halves 14, 16 of the clamshell are molded with an arrangement of nests receiving drive assembly 36 so that the latter is prevented from displacement during operation of the inventive tool assembly. Although a structure, as shown in the drawings, is powered by an external source, slight structural modifications can allow for use of internal power sources, such as a pack of powerful batteries.

Drive assembly 36 further includes a toothed wheel or male cog 46 (FIGS. 2 and 1A), mounted on the distal end of output shaft 42, for mesh engagement with a drive mechanism female cog of multiple interchangeable attachments, as will be explained hereinbelow.

To selectively couple the interchangeable attachments to tool body 12, its distal portion 20 has an opening 48 (FIG. 1A) defined by two halves of clamshell 14, 16 and providing access to output shaft or spindle 42. Opening 48 has a dual function. Firstly, as mentioned before, it receives the proximal end of the attachments. Secondly, due to its geometry, it defines a locking system generally referenced as 50 (FIG. 1A) and configured to lock the coupled attachment relative to tool body 12 for further operations.

Locking mechanism 50 has a structure of a bayonet connection and includes angularly spaced recesses 52 (FIG. 1A) and a guide channel 54. To insert the attachment, the user initially aligns the attachment's proximal end, which will be disclosed hereinafter in detail, with opening 48 and then moves the attachment into this opening. Upon insertion of the attachment, the user applies a torque causing tool body 12 and the attachment to rotate relative to one another to a locking position of the attachment. At least one rib 56, (FIG. 1A) bridging guide channel 54, functions as a stop and arrests displacement of the attachment, defining thereby its locking position. The user may then apply a force to actuating button 24 (FIGS. 1A and 3) causing lever 22 to move toward distal portion 20 of tool body 12 and flip switch 34 (FIG. 2) to the on-position. To ensure coupling between the attachment and tool body 12 and to prevent accidental rotation the attachment in the locking position, trigger lever 22 is provided with an attachment lock 60 (FIGS. 1A and 3) which is movable with this lever to extend beyond an aperture 58 (FIG. 1A) towards a similarly shaped aperture on the proximal end of the attachment, which is aligned with aperture 58 in the locking position. As the locking position has been established, switch 34 (FIGS. 1A, 2) assumes its on-position causing rotation of output shaft 42 and male cog 46, which rotation is further transmitted to the output shaft of the attachment by a transmission assembly mounted within an housing of each attachment, as will be further explained in detail.

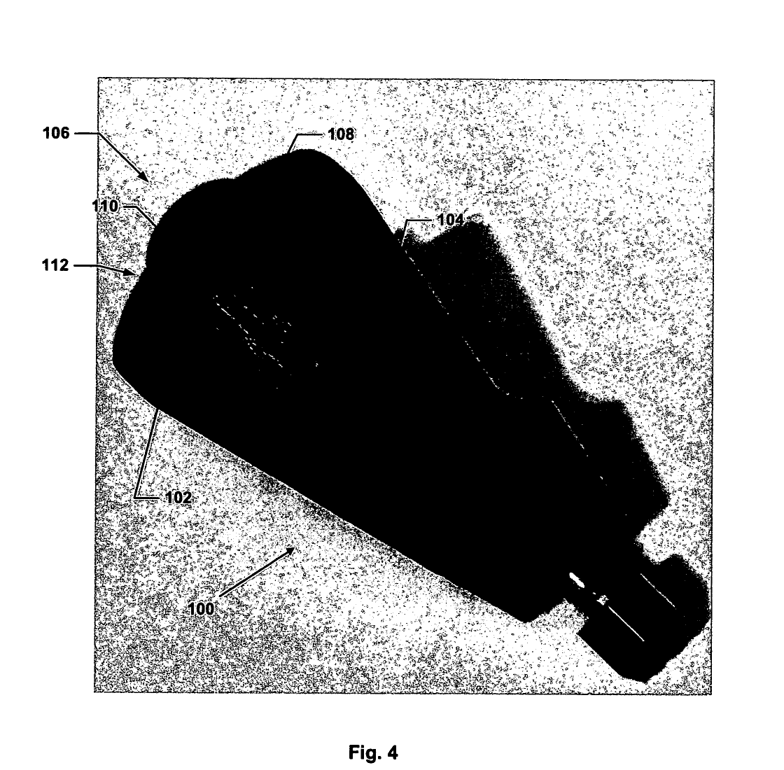

A plurality of interchangeable tool attachments are shown in FIGS. 4-16 and are selectively attachable to drive mechanism 36 (FIG. 2) of tool body 12 to form a particular type of power tool having a dedicated function. The particular types of tool attachments will include, among others, a chiseling unit, a drilling unit, a screw-driving unit and a sanding unit. Each of the tool units is configured with a coupling assembly for engagement with drive mechanism 36 (FIG. 2), which, via output shaft 42 and male cog 46, will drive the accessories coupled to the attachment.

One of the interchangeable tool attachments is a chiseling unit 100 operative to perform chiseling and gouging operations, as illustrated in FIGS. 4-7. Chiseling unit 100 has an housing comprised of two halves 102 and 104, which are detachably coupled to one another to form a generally frustoconical body or housing in the assembled state of unit 100. Chiseling unit 100, like all of the other attachments, is configured with a uniform connection system 106 configured with a substantially cylindrical proximal body portion 108 (FIG. 4) which is ergonomically designed to match the exterior contour of distal portion 20 of tool body 12 (FIG. 2) when the attachment is connected thereto. The design of the proximal body portion may vary for different types of tool head attachments and generally serves to provide an optimal profile to the power tool dependent on its particular function.

Extending outwards from proximal body portion 108 is a cylindrical flange 110 provided with a pair of angularly spaced apart lugs 112 extending radially in opposite directions from the outer periphery of flange 110. Lugs 112 each are shaped and dimensioned to fit recesses 52 and slide along guide channel 54 (FIG. 1A) to the locking position during attachment of chiseling unit 100 to tool body 12.

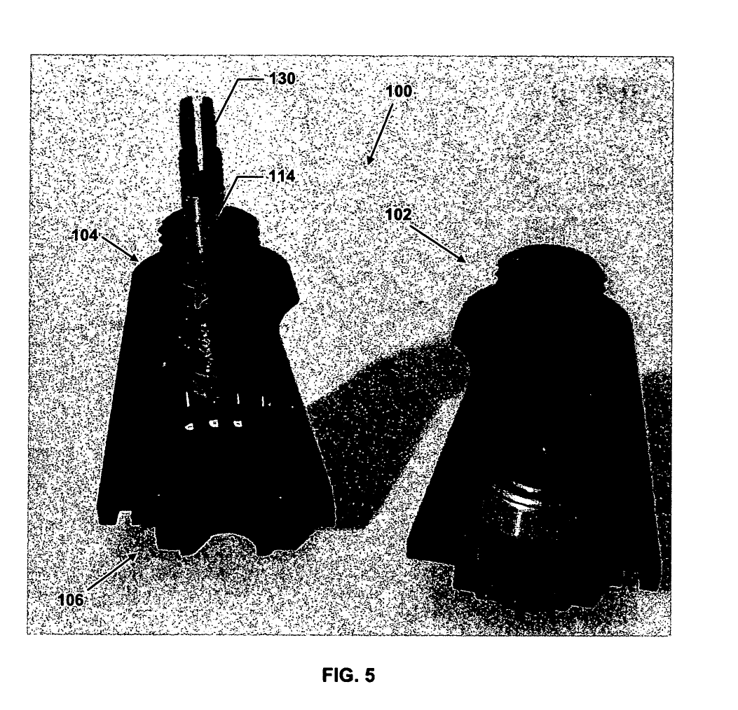

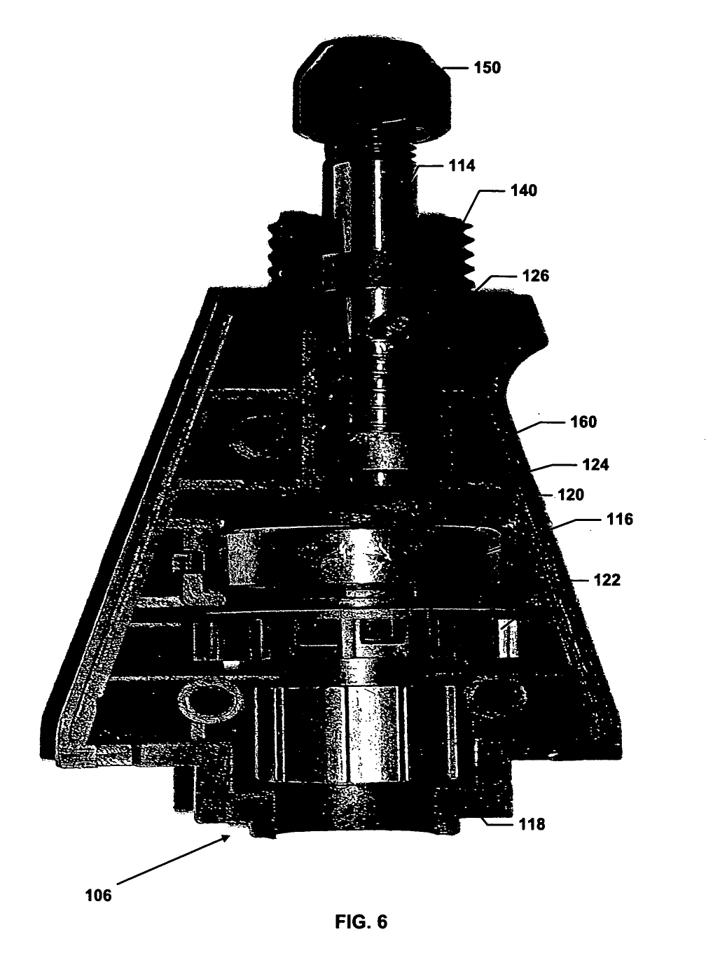

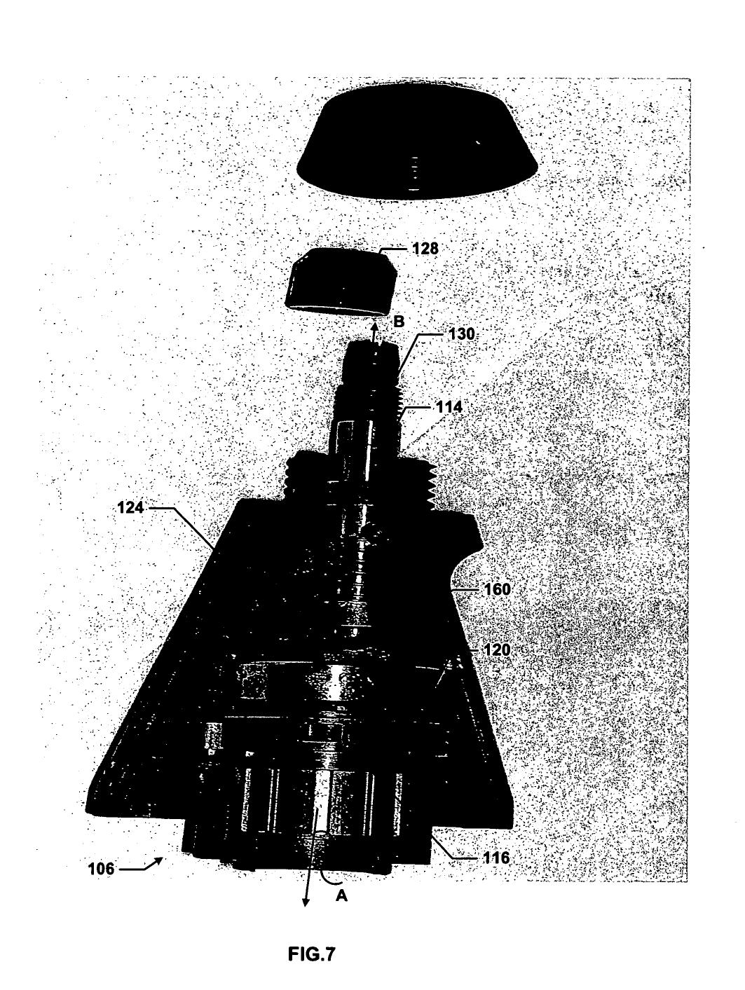

The interior of the unit's body, as shown in FIGS. 5-7, is provided with an arrangement of nests and stoppers configured to receive and retain an oscillating transmission translating rotational motion of output shaft 42 (FIG. 2) into linear reciprocating motion of an output shaft 114 of unit 100, as is explained in detail below. The transmission includes an input shaft 116 (FIGS. 6, 7) having a female cog 118, which is keyed to the proximal end of shaft 116 and meshes with male cog 46 of drive assembly 36 of tool body 12 (FIG. 2) to provide synchronous rotation of output shaft 42 and input shaft 116 of body 12 and unit 100, respectively. The opposite distal end of input shaft 116 is surrounded by a bearing 120 received in one of the nests so that shaft 116 does not deviate from the desired position, in which shaft 116, female cog 118 and a balancing wheel 122 are coaxially mounted about an axis of symmetry A (FIG. 7) of the rear body portion 108, which is aligned with the axis of rotation of input shaft 42 of tool body 12.

Distal end 124 (FIG. 6) of input shaft 116 is slanted to form a cam surface necessary for oscillating motion of output shaft 114 of chisel unit 100. This output shaft 114 extends along an axis B (FIG. 7), which is offset from axis A of proximal body portion 108 to form an eccentric cam follower, and is spring loaded by a resilient element 126 (FIG. 6) biasing output shaft 114 away from the distal end of input shaft 116 during an operation of chisel unit 100, as explained immediately below.

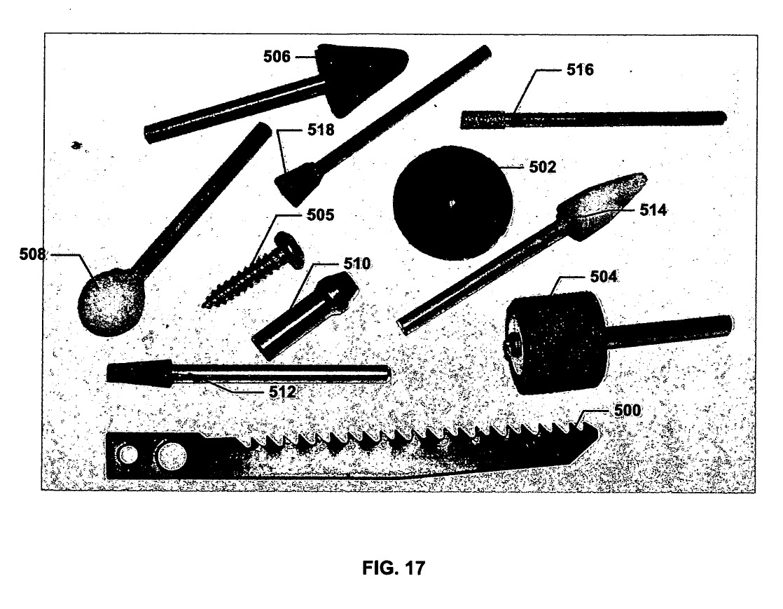

To operate chisel unit 100, the user inserts accessories including, among others, chisels or gouges, which can be seen among a group of accessories in FIG. 17, in a split distal end 130 (FIGS. 5 and 7) of output shaft 114 and tightened the halves of the split distal end by a collet nut 128. Assembly of chisel unit 100 is completed by capping a threaded distal end 140 (FIG. 6) of unit 100 by a cap 150 having an inner, i.e. internal, thread.

Upon attaching chiseling unit 100 to tool body 12 and turning assembly 10 on, as disclosed above, the user applies a force to tool body 12 bringing the mounted accessory into contact with a surface to be treated. A reaction force produced by the surface pushes output shaft 114 inwards causing its proximal end 160 to press against slanted distal end 124 of input shaft 116 (FIGS. 6 and 7). As a result, during the rotation of input shaft 116, the cam surface of its slanted distal end 124 actuates output shaft 114 so that both shaft 114 and the mounted accessory linearly reciprocate in an axial plane.

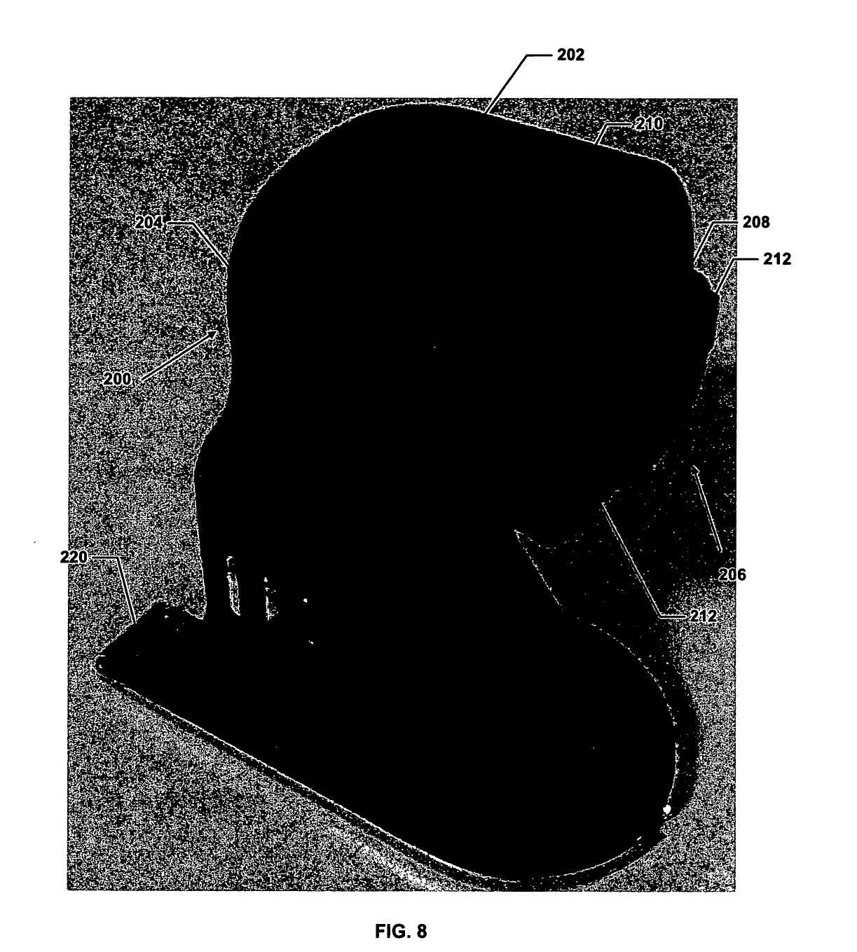

FIGS. 8-11 illustrate a reciprocating saw unit 200 configured with a body 210 provided with two halves 202 and 204, which are detachably coupled to one another and can be easily separated upon applying a tensile force by the users. Proximal portion 206 of body 202 is configured similarly to proximal portion body 108 (FIG. 4) of chisel unit 100 and has a flange 208 defining an aperture, which receives male cog 46 (FIG. 2) of drive mechanism 36 of tool body 12 (FIG. 2) during attachment of saw unit 200. Upon insertion of saw unit 200, spaced lugs 212 (FIG. 8) are received in recesses 52 (FIG. 1A) of body 12 and, after the user applies a torque to inserted components, are guided in guide channel 54 to the locking position of saw unit 200 in this body.

In operation, saw unit 200 is typically placed on a support surface and is displaceable in accordance with a force applied by the user to unit's body 210. To facilitate displacement of saw unit 200 along the support surface, body 210 is detachably mounted on a plate 220 made from material having a low friction coefficient.

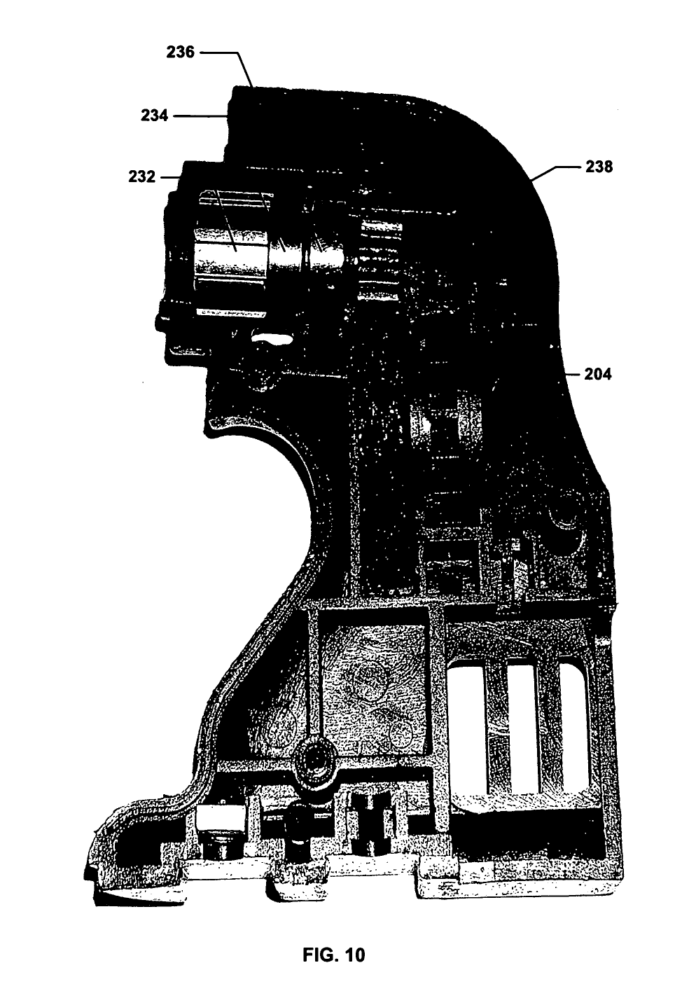

The interior of saw unit 200 receives a reciprocating transmission mechanism configured to translate rotational motion of output shaft 42 (FIG. 2) into linear reciprocating motion of a blade, shown in FIG. 17. The transmission includes a female cog 232 (FIG. 10), which is mounted coaxially with and next to flange 208 (FIG. 8), to mesh with male cog 46 (FIG. 1A) of drive mechanism 36 (FIG. 2). Female cog 232 is keyed to input shaft 234 (FIG. 10), which has a distal end extending through a bearing 236 and fixed to a gear 238. Upon locking saw unit 200 in tool body 12, female cog 232 meshes with male cog 46 (FIG. 1A) to rotate and actuate input shaft 234 and gear 238.

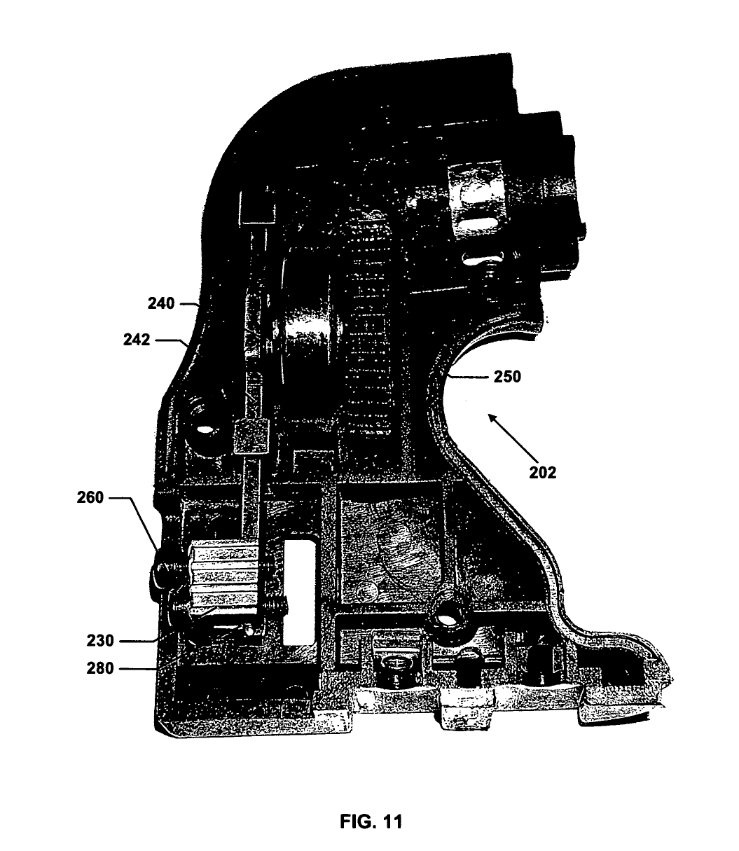

To translate rotational motion of input shaft 234 into reciprocal motion of saw blade, gear 238 meshes with a gear 250 to form a speed reduction gear transmission ratio. The output shaft of the transmission, mounted coaxially with and fixed to gear 250, has a distal end, which is provided with an eccentrically mounted pin 240 (FIG. 11). The shape and dimension of pin 240 are selected so as to allow this pin 240 to extend through an aperture formed in a lever 242 (FIG. 11) and run along a closed path along the inner peripheral wall of the aperture.

Accordingly, during the rotation of the input and output shafts of the transmission, pin 240 is guided along and presses against the opposite races of the aperture. When pin 240 presses against the upper race, lever 242 moves in one direction, whereas pressing against the lower race causes lever 242 to move in the opposite direction.

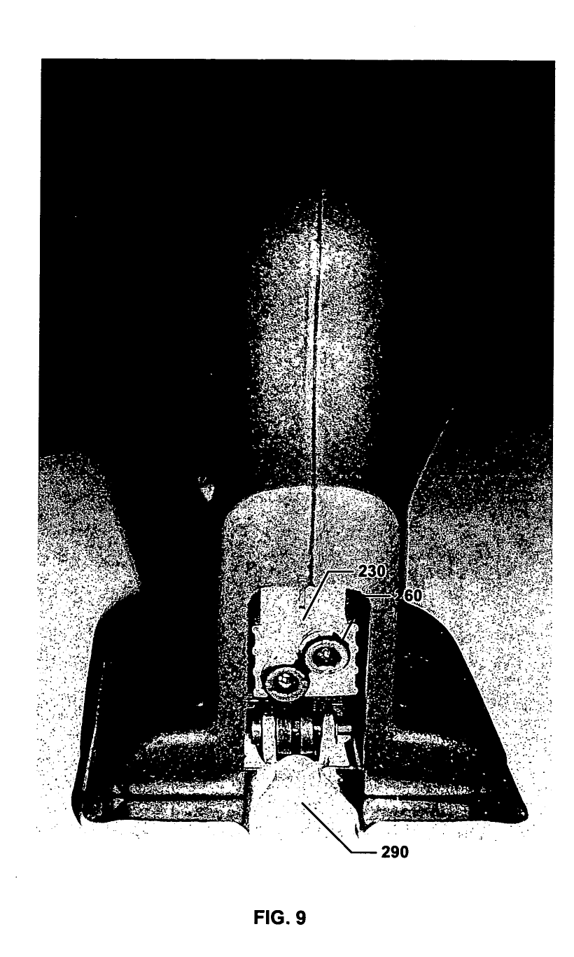

Lower end of lever 242 is removably coupled to a saw blade by a blade holder 230 (FIGS. 9 and 11), which is slidably mounted on this lower end. To couple the saw blade to holder 230, the user loosens a tightening screw or screws 260, slightly pull holder 230 away from lever 242 so as to form a space 280 (FIG. 11). The blade is then inserted into this space 280 and fixed to holder 230 and lever 242 by tightening screw 260. In operation, the longitudinal body of the blade extends from the lower end of lever 242 through a space 290 (FIG. 9) and is forced to move up and down by lever 242. Note that saw unit 200 may operate with a variety of accessories, for example, a gouge.

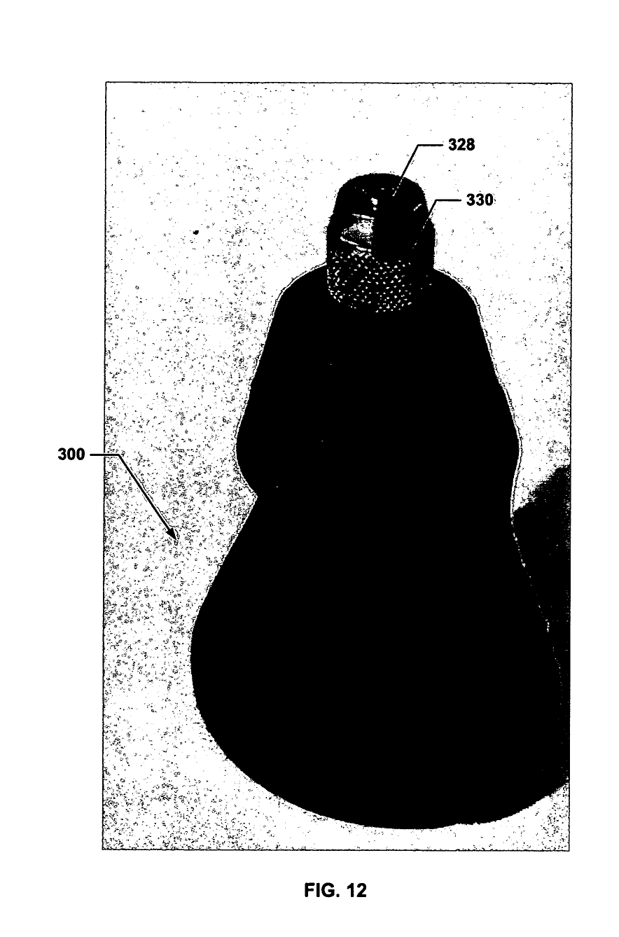

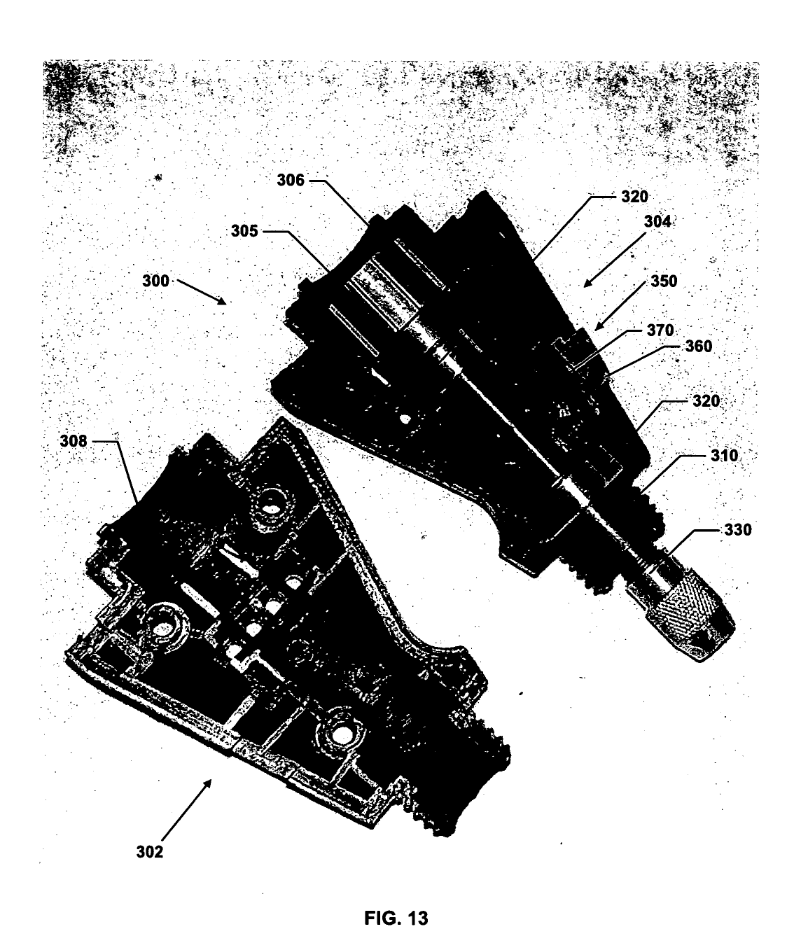

FIGS. 12 and 13 illustrate a drilling unit 300 operative to selectively receive numerous accessories performing drilling, sanding, grinding, and polishing functions. Drilling unit 300 is configured with two halves 302, 304 detachably coupled to one another to form a generally frustoconical body similar to the body of chiseling unit 100. Similarities to the aforementioned unit also include an attaching assembly defined by a proximal portion 306 couplable to tool body 12. In particular, when assembled, halves 302 and 304 form an opening provided with a flange 308 which is shaped and dimensioned to fit opening 48 (FIG. 1A). Two lugs, formed on the outer periphery of flange 308, are received in recesses 52 (FIG. 1A) providing, thus, a proper alignment between tool body 12 and unit 300. In response to a torque applied by the users, unit 300 and body 12 rotate relative one another to the locking position.

Upon insertion of unit 300, male cog 46 (FIG. 1A) of drive mechanism 36 (FIG. 2) meshes with a female cog 305 (FIG. 13) of a transmission, enclosed by halves 302, 304. Accordingly, the transmission is operative to rotatably couple output shaft 42 (FIG. 2) of drive mechanism 36 to accessories including, among others, grinding stones, drills, grinding and polishing discs, which can be selectively coupled to unit 300.

Keyed to female cog 306 is a shaft 310 (FIG. 13) extending coaxially with shaft 42 (FIG. 2) of drive mechanism 36 of tool assembly 10 upon attaching unit 300 to tool body 12. Spaced bearings 320, received in respective nests of halves 302, 304 rotatably support proximal and distal ends of shaft 310 to prevent the transmission from undesirable oscillations during the operation of unit 300. The distal end of shaft 310 is hollow and configured to slidably receive a collet 328 (FG. 12), which is adapted to selectively receive multiple accessories including, for example, polishing sticks or cutting and sanding discs. Upon insertion of the selected accessory, it is tightened in the mandrel by a collet nut 330 screwed on the threaded distal end of shaft 310.

Replacing accessories is facilitated by a spring-loaded stop 350 including a button 360 and a spring loaded stem 370. Stop 350 operates to prevent shaft 310 from rotational motion while detaching collet nut 330 from the distal end of shaft 310, when a need exists to change accessories. In operation, the user applies a force to button 360 directed generally perpendicular to the rotation axis of shaft 310 and sufficient to displace stem 370 against the spring force towards and engage shaft 310, preventing the latter from rotation. Accordingly, the user may apply a sufficient torque to nut 330 and unscrew it from shaft 310. As collet nut 330 is loosened, the force is seized, and the spring forces shank 370 away from shaft 310. Once a new accessory with is mounted, the user screws collet nut 330 again onto the threaded distal end of shaft 310 to prevent the new accessory from accidental detachment from collet 328.

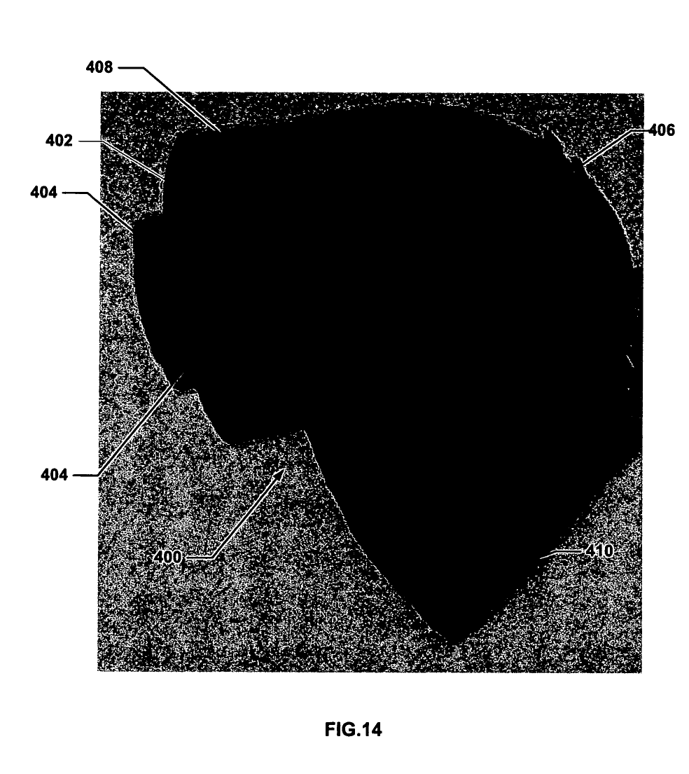

FIGS. 14-16 illustrate a sanding unit 400 also having two halves 406 and 408 forming a curved body in the assembled state of unit 400. A proximal end 402 of this unit is shaped to conform to the outer profile of distal portion 20 of tool body 12 (FIG. 2), whereas a distal end 406 extends transversely to proximal end 402 and terminates with a pad 410, which detachably receives sanding paper.

An attaching mechanism formed on proximal end 402 is configured identically to the attaching mechanism of units 100, 200 and 300 and, thus, will not be discussed in detail. Suffice it to say, when sanding unit 400 is attached and locked to tool body 12, an input portion of a transmission housed in the body of the unit 40 is aligned with output shaft 42 (FIG. 2) of drive mechanism 36.

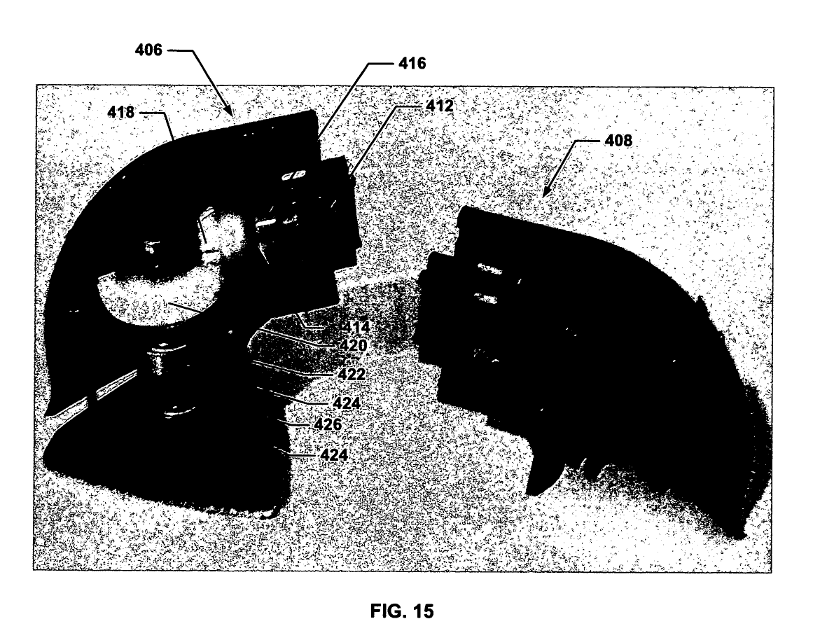

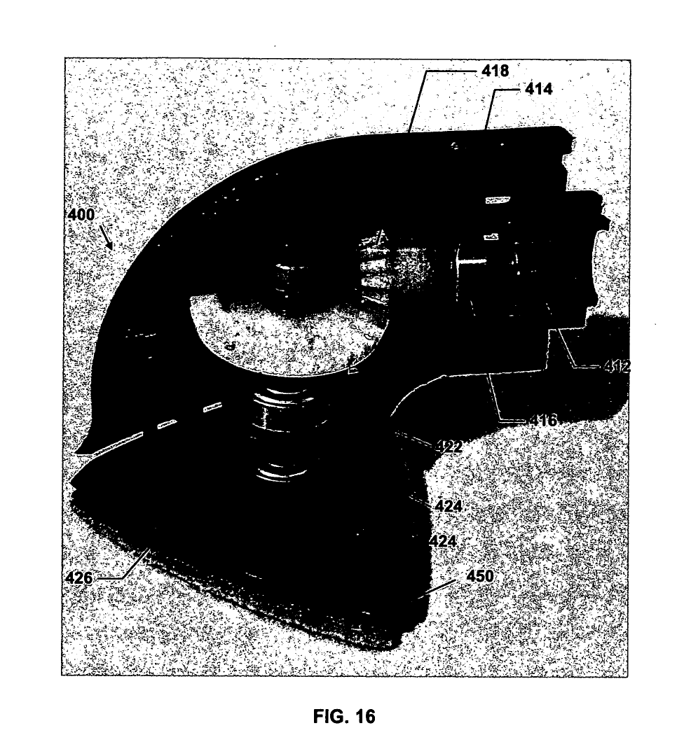

As the aforementioned units, the input portion of transmission includes a female cog 412 (FIG. 15) meshing with male cog 46 of drive mechanism 36 (FIGS. 1A and 2) and is rotatably fixed to an input shaft 414, which, in turn, is mounted on a bearing 416. A reduction gear includes an upstream beveled gear 418 mounted on the distal end of input shaft 414 and a downstream beveled gear 420 rotatably fixed to an output shaft 422. Output shaft 422 is provided with a pair of spaced bearings 424 (FIGS. 15, 16) and an eccentric 426, which is rotationally fixed to output shaft 422 between bearings 424.

In operation, rotation of input shaft 414 causes rotation of gears 418 and 420 that in turn actuates output shaft 422 and eccentric 426. Uneven distribution of the mass of eccentric 426 causes the body of unit 400 to vibrate in a plane of surface to be sanded. As a result, sanding paper 450 (FIG. 16), rigidly attached to the body, performs the dedicated sanding task.

As discussed above, FIG. 17 illustrates multiple accessories associated with units 100, 200 300 and 400. Blade 500 is shown on the bottom of FIG. 17. Accessory 502 may be a cutting or sanding disc utilized during the operation of drilling unit 300. Accessories 504, 516, 508, 512 and 514 represent different configured grinding stones. Element 510 is shown to better illustrate a collet and element 516 is a mandrel used for attaching certain accessories to collet 328 of drilling unit 300 shown in FIG. 12. In addition to the above-discussed functions, drilling unit 300 can be used a conventional drill for driving screws 505.

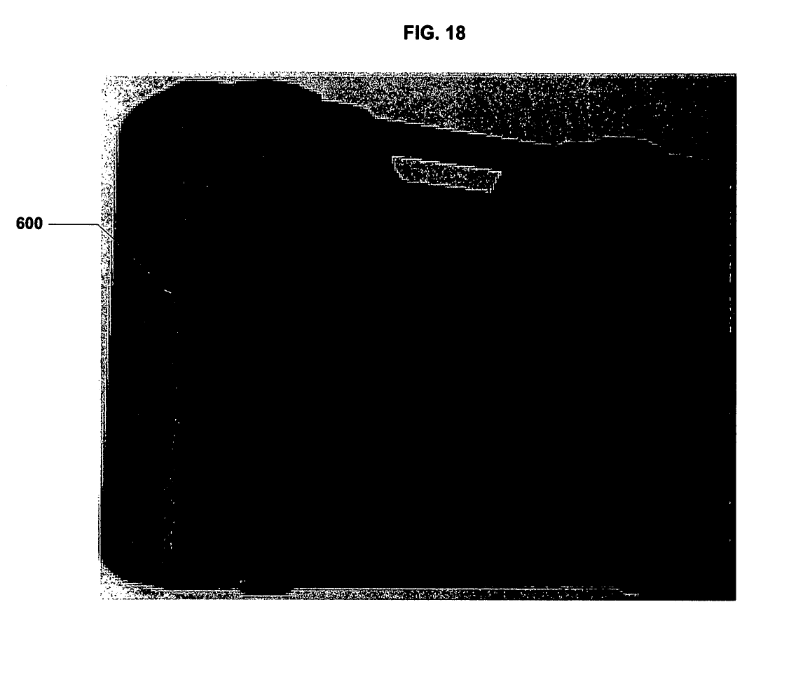

While inventive power tool assembly can be manufactured and marketed in any combination necessarily including tool body 12, which houses drive mechanism 36 (FIG. 2), and any of the disclosed units 100-400, advantageously, tool assembly 10 is manufactured as a kit including these and other units. Ergonomically designed components of tool assembly 10 can be easily placed in a tool box 600, as shown in FIG. 18, which is easy to transport and store.

This document describes the inventive sound transfer methods and devices implementing these methods for illustration purposes only. Neither the specific embodiments of the invention as a whole, nor those of its features limit the general principles underlying the invention. In particular, the invention is not limited to the disclosed attachments and particular accessories. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention.

What is claimed is:

1. A power tool assembly comprising:
a tool body;
a drive unit in the tool body; and
a plurality of tool attachments selectively couplable to the tool body in a coupling position, each of the plurality of tool attachments and the tool body being lockable with one another upon rotating the tool attachment and the tool body relative to one another from the coupling position to a locking position, wherein the plurality of tool attachments each is operable to perform a dedicated task upon powering the drive unit in the locking position of the tool attachment.

2. The assembly of claim 1, wherein the drive unit has a drive shaft rotatable about an axis upon powering the drive unit and a first cog rotatably fixed to the drive shaft.

3. The assembly of claim 2, wherein each of the tool attachments comprises:
an housing,
a transmission unit mounted in the housing and configured to transmit rotational motion of the drive shaft to a tool coupled to the tool attachment, the transmission unit having a first shaft extending along a first axis, the first axis being aligned with the axis of the drive shaft in the locking position of the tool attachment, and
a second cog fixedly mounted on the first shaft and meshing with the first cog of the tool body in the locking position to rotatably couple the drive shaft of the drive unit with the first shaft of the tool attachment.

4. The assembly of claim 3, further comprising a bearing mounted on the first shaft and a balancing wheel mounted on the first shaft between the bearing and the second cog, the balancing wheel supporting the first shaft in axial alignment with the coupled drive shaft of the drive unit of the tool body.

5. The assembly of claim 3, wherein the transmission unit has a second shaft centered about a second axis and axially biased towards a distal end of the first shaft so that a proximal end of the second shaft is in contact with the distal end of the first shaft, a distal end of the second shaft being configured to receive the tool, the first and second axes of the respective first and second shafts being parallel to and laterally offset from one another, the tool being a chisel or gouge.

6. The assembly of claim 5, wherein one of the distal end of the first shaft and the proximal end of the second shaft has a slanted surface configured so that when the first shaft rotates about the first axis in the locking position of the tool attachment, the second shaft axially oscillates.

7. The assembly of claim 5, further comprising a nut threadedly engaging the distal end of the second shaft so as to prevent displacement of the tool relative to the second shaft.

8. The assembly of claim 3, wherein the transmission system comprises:
a second shaft of the tool attachment extending along a second axis, the first and second axes of the respective first and second shafts being parallel to and laterally offset from one another, and
a speed reduction mechanism including a first gear and a second gear, the first gear being mounted on a distal end of the first shaft and rotatable therewith about the first axis, the second gear being rotatably fixed to the second shaft and meshing with the first gear.

9. The assembly of claim 8, further comprising:
a pin eccentrically mounted to a distal end of the second shaft and rotatable therewith,
a lever extending transversely to the first and second axes and having an aperture aligned with the pin, the pin extending through the aperture and running along a closed path along a periphery of the aperture to translate rotational motion of the first and second shafts into linear reciprocating motion of the lever.

10. The assembly of claim 9, further comprising:
an holder mounted to a bottom of the lever and operable to axially slide relative to the lever,
a tool insertable between the holder and the lever; and
a coupling element extending through the holder and the lever and operable to displaceably fix the tool to the holder and to the lever.

11. The assembly of claim 10, further comprising a plate detachably mounted to the tool attachment and having a recess aligned with the tool, wherein the tool is reciprocally movable through the recess.

12. The assembly of claim 3, wherein the first shaft of the tool attachment has a hollow distal end configured to receive the tool.

13. The assembly of claim 12, further comprising:
a collet removably insertertable into the hollow distal end of the first shaft and receiving the tool,
a collet nut threadedly engaging the distal end of the first shaft so as prevent detachment of the tool from the collet, and
a spring loaded stop extending transversely to the first shaft and operable to press thereagainst to prevent rotation of the first shaft while the nut being detached from the distal end of the first for removing the tool from and placing the tool in the collet.

14. The assembly of claim 3, wherein the transmission unit further has:
a second shaft centered on a second axis, the first and second axes of the respective first and second shafts extending transversely to one another,
a first beveled gear rotatably fixed to the first shaft,
a second beveled gear rotatably fixed to the second shaft and meshing with the first gear to provide a speed reduction mechanism.

15. The assembly of claim 14, further comprising an eccentric rotatably fixed to the second shaft so as to provide the tool attachment with oscillatory motion in the locking position of the tool attachment, the tool being displaceably fixed to the tool attachment and comprising a sanding paper.

16. The assembly of claim 1, wherein the plurality of tool attachments each has an housing provided with two detachably connected shells.

17. The assembly of claim 2, wherein the tool body is provided with axially opposite proximal and distal ends and a peripheral wall extending between the proximal and distal ends, the distal end of the tool body defining an opening dimensioned to receive a proximal end of the selected tool attachment in the coupling position.

18. The assembly of claim 17, further comprising:
an actuating lever displaceable in the tool body to an on-position to power the drive unit, and
a lock mounted in the tool body and coupled to the actuating lever so as to axially move therewith towards and penetrate the proximal end of the tool attachment in the locking position thereof, wherein the lock prevents relative rotation between the tool body and the tool attachment from the locking position to the coupling position upon extending into the proximal end of the tool attachment.

19. The assembly of claim 18, wherein the peripheral wall of the tool body has an axial channel opening at the distal end of the tool body, the proximal end of the tool attachment having a slot aligned with the axial channel in the locking position of the tool attachment, the lock having opposite ends terminating in the axial channel of the tool body and the slot of the tool attachment, respectively, in the on-position of the actuating lever.

20. The assembly of claim 19, further comprising:
a trigger button mounted on the actuating lever and displacing the actuating lever to and from the on-position in response to an external force applied to the trigger button,
a trigger button provided on the actuating lever and displaceable therewith, and
a switch mounted in the tool body and engageable by the trigger button during displacement of the actuating lever so that the switch couples the drive unit to a power source in the on-position of the actuating lever.

21. The assembly of claim 18, wherein the actuating lever and the lock are integrally formed with one another.

22. The assembly of claim 18, wherein the actuating lever and the lock are detachably coupled to one another.

23. The assembly of claim 17, further comprising a coupling unit between the tool body and the tool attachment, the coupling unit comprising:
a circumferential guide channel provided in an inner surface of the peripheral wall of the tool body and located adjacent to the distal end the tool body;
a flange provided on the proximal end of the tool attachment and receivable in the opening of the tool body in the coupling position of the tool attachment, and
a first lug provided on the flange and extending radially outwards therefrom, the guide channel receiving the lug in the coupling position of the tool attachment and circumferentially sliding in the guide channel to the locking position of the tool attachment upon applying a torque to at least one of the tool attachment and tool body.

24. The assembly of claim 23, wherein the distal end of the tool body has a first recess extending radially outwards from the opening of the distal end of the tool body towards the peripheral wall, the first recess being axially aligned with the first lug of the tool attachment in the coupling position thereof and being dimensioned to receive and guide the first lug into the guide channel.

25. The assembly of claim 24, wherein the coupling unit further comprises a rib provided in the circumferential channel and spaced angularly from the first recess, the rib abutting the first lug upon circumferentially displacing the first lug along the guide channel from the coupling position of the tool attachment to the locking position thereof

26. The assembly of claim 23, wherein the coupling unit further comprises:
a second lug spaced angularly from the first lug, and
a second recess in the distal end of the tool body angularly spaced from the first recess, the second recess and the second lug being axially aligned with one another in the coupling position of the tool attachment.

27. The assembly of claim 1, wherein the tool body has two shells detachably coupled to one another and provided with an arrangement of nests on an inner surface of the shells receiving the drive assembly.

28. The assembly of claim 27, wherein the tool body has a bent between the proximal and distal ends thereof.

29. The assembly of claim 20, wherein the power source is external or internal.

30. A power tool kit comprising:
a tool body;
a drive unit in the tool body and having a drive shaft; and
a plurality of tool attachments selectively couplable to the tool body in a coupling position, the plurality of tool attachments each being operable to perform a dedicated task and being lockable with the tool body upon rotating the tool attachment and the tool body relative to one another from the coupling position to a locking position;
a plurality of tools couplable to the respective tool attachments;
a transmission mechanism mounted in each of the plurality of tool attachments and operable to transmit a rotational movement of the drive shaft to the tool coupled to the tool attachment; and
a portable tool box configured to store the tool body, the plurality of tool attachments and the plurality of tools.

31. The kit of claim 30, wherein each of the tool attachments comprises:
an housing,
a transmission unit mounted in the housing and configured to transmit rotational motion of the drive shaft to a tool coupled to the tool attachment, the transmission unit having a first shaft extending along a first axis, the first axis being aligned with the axis of the drive shaft of the drive unit in the locking position of the tool attachment, the drive shaft of the tool body and the first shaft of the drive unit of the tool attachment being rotatably coupled to one another in the locking position.

32. The kit of claim 31, wherein the drive and first shafts of the drive unit and tool attachment, respectively, are aligned with one another in the locking position.

33. The kit of claim 31, wherein the transmission unit has a second shaft centered about a second axis and axially biased towards a distal end of the first shaft so that a proximal end of the second shaft is in contact with the distal end of the first shaft, a distal end of the second shaft being configured to receive the tool, the first and second axes of the respective first and second shafts being laterally offset from one another.

34. The kit of claim 33, wherein one of the distal end of the first shaft and the proximal end of the second shaft has a slanted surface configured so that when the first shaft rotates about the first axis in the locking position of the tool attachment, the second shaft axially oscillates.

35. The kit of claim 33, wherein the tool attachment further comprises a nut threadedly connected to the distal end of the second shaft so as to prevent displacement of the tool relative to the second shaft.

36. The kit of claim 31, wherein the transmission system comprises:
a second shaft of the tool attachment extending along a second axis, the first and second axes of the respective first and second shafts being parallel to and laterally offset from one another, and
a speed reduction mechanism including a first gear and at least one second gear, the first gear being mounted on a distal end of the first shaft and rotatable therewith about the first axis, the second gear being rotatably fixed to the second shaft and meshing with the first gear.

37. The kit of claim 36, further comprising:
a pin eccentrically mounted to a distal end of the second shaft and rotatable therewith,
a lever extending transversely to the first and second axes and aligned with the pin, the pin extending through the aperture and running along a closed path along a periphery of the aperture to provide the lever with linear reciprocating motion in the locking position of the attachment unit.

38. The kit of claim 37, further comprising:
an holder mounted to a bottom of the lever and operable to axially slide relative to the lever,
a tool insertable between the holder and the lever; and
a fastener extending through the holder and the lever and operable to displaceably fix the tool to the holder and to the lever.

39. The kit of claim 38, further comprising a plate detachably mounted to the tool attachment and having a recess aligned with the tool so that the tool reciprocally moves through the recess as the second shaft rotates, the tool being a saw blade.

40. The kit of claim 31, wherein the first shaft of the tool attachment has a hollow distal end configured to receive the tool, the tool being a polishing stick, a cutting disc or a sanding disc.

41. The kit of claim 40, further comprising:
a collet removably insertertable into the hollow distal end of the first shaft and selectively receiving the tool,
a collet nut threadedly engaging the distal end of the first shaft so as prevent detachment of the tool from the first shaft, and
a spring loaded stop extending transversely to the first shaft and operable to press thereagainst to prevent rotation of the first shaft while detaching the nut from the first shaft to remove the tool from the hollow distal end.

42. The kit of claim 31, wherein the transmission unit further has:
a second shaft centered on a second axis, the first and second axes of the respective first and second shafts extending transversely to one another,
a first beveled gear rotatably fixed to the first shaft,
a second beveled gear rotatably fixed to the second shaft and meshing with the first gear to provide a speed reduction mechanism.

43. The kit of claim 42, further comprising an eccentric rotatably fixed to the second shaft so as to provide the tool attachment with oscillatory motion in the locking position of the tool attachment, the tool being displaceably fixed to the tool attachment and comprising a sanding paper.

44. The kit of claim 30, wherein the plurality of tool attachments is selected from the group consisting of a chiseling unit, drilling unit, screw-driving unit and a sanding unit and a combination thereof.

45. The kit of claim 30, wherein the plurality of tools is selected from the group consisting of saw blades, cutting discs, sending discs, chisels, gouges, screws, nuts, and grinding stones and a combination thereof.
